(19) United States
(12) Patent Application Publication
(10) Pub. No.: US 2011/0078276 A1
(43) Pub. Date: Mar. 31, 2011

(54) Method of Scalable Web Financing By Micropayments

(76) Inventor: J. Mark Johnston, McLean, VA (US)

(21) Appl. No.: 12/567,906

(22) Filed: Sep. 28, 2009

(51) Int. Cl. G06F 15/16; G06F 17/30

(52) U.S. Cl. 709/217; 707/E17.108

(57) ABSTRACT

A method is disclosed of scalable web financing by micropayments that 1) equitably and automatically allocates costs among web site users that may have varying usage patterns; 2) lowers the risk in providing niche websites to smaller groups of users; 3) provides a funding source directly related to web site usage by particular users; 4) allows the web site to scale with demand; and 5) provides incentives for provision of content to a web site that is timely and useful. A microcost is determined for each element of web site content. A micropayment is transferred from a user's web site account to a web site operator account in an amount equivalent to the determined microcost when the user accesses the web site content. Various methods of calculating the microcost are disclosed, as well as methods of compensating content-providers with micropayments or credits, as a means to provide incentives for provision of content.

### BACKGROUND OF THE INVENTION

1. Field of the Invention

The present invention generally relates to systems and methods for scaling web site resources to meet the demands of users without advertisement or sponsorship.

2. Background

The growth of the internet has provided a wealth of resources for anyone with access to an internet connection. Nearly any bit of knowledge can be found or studied by using the internet. Indeed, if anything, there can be too much information available for any particular query.

One popular method of obtaining knowledge from the internet is to use a search engine. After a query or search term is put into the search engine, typically a list of query responses is returned and displayed. These responses are organized and prioritized by the search engine. There may be hundreds, even thousands, of responses returned by the search engine. Although search queries can be revised, often such revisions still generate hundreds or thousands of possibly different responses. Typically, in a user's search for increased understanding, or an answer to a question, a search engine response list is studied and sampled. For many queries, it may take a considerable amount of time to inspect and parse through the returned query responses until a useful result is actually found.

Even when it appears that a response containing possibly useful content is found, a user's more detailed consideration of the content may determine that the response does not represent reliable information. It is at least difficult, perhaps impossible, for average users to determine if the content being considered is authoritative. Even when authoritative, the content being considered may be partially inaccurate. Users may need to devote further research, time and study. Extensive search response lists also may include significant result duplication: content may often be re-purposed, re-packaged, syndicated or otherwise re-distributed. It may also be difficult to ascertain whether the returned content is timely.

An alternative to using a generalized search engine is to consult a “knowledge” web site in the field of the user's inquiry. Knowledge web sites come in many forms but typically would be structured as message boards or blogs dedicated to knowledge of one or more subject areas. They may require registration and/or a fee in order to access content. They may allow collaboration—dialog among members—or be structured as one-way presentations of knowledge as in a FAQ web page or set of web pages. Knowledge web sites further may use a moderator to filter content for posting, approve membership changes or retrieve content. These sites also may include internal and dedicated search engines. If their data has been indexed by external search engines, some knowledge web sites may be searched directly using a large search engine such as Google, Yahoo or Bing. Often, the internal knowledge web site search engines are not well-developed usually allowing just simplified keyword/index types of searches.

Knowledge web sites also may not be well-sized for their purpose. They can be too large—attempting to cover a very large amount of general subject matter, so that finding a specific needed piece of information is very difficult. Or, they can be too small, attempting to cover such a tiny amount of subject matter that no one actually finds the site, or visits or uses the site.

It is difficult, perhaps impossible, to know in advance how best to scale a knowledge website for its intended audience. Level of demand for information that is intended to be supplied at a proposed knowledge web site is unknown at first, there being alternative sources of information for almost anything—general online searches, other websites, written or online product manuals, etc. Demand for information may also depend on the quality of the information, including its timliness, completeness and other factors. Demand for information may further depend not just on the content within the site but also its appearance, usability and marketing.

If a web site is extremely successful, the web site is likely to outgrow its hardware implementation with the consequence of slow or non-existent service to the web site's users. If a web site is unsuccessful, the initial investment in hardware and software systems may have been unnecessary, or a smaller investment would have been sufficient. There appears to be no reliable system or method for controlling risk by tailoring web site investment and resources where demand for the web site services is largely unknown. The existence of this risk may be a deterrent to the launch of possibly very useful niche web sites to the detriment of users who would benefit from such sites.

It is similarly difficult to know in advance which elements of all the content within a particular website will prove to be the most requested. Demand for content may change with time; what was most in demand at a particular time may no longer be in demand as time goes on. There appears to be no reliable system or method for tailoring web site content to that which is in most demand at a particular time.

Creating and maintaining a quality web site requires a wide assortment of costs. These costs include but are not limited to hosting, hardware, software, marketing, content creation, moderating and internet access costs. Generally, costs increase with the number of users and with the sophistication, extent and duty cycle of the web site content. Not only is it difficult to forecast demand for the web site, and therefore its costs, it is also difficult to equitably allocate costs among users with varying usage patterns. Knowledge web sites may have a great many users, or only a few users. Yet, some users will use the site to a much greater extent than other users. Typical funding mechanisms for web sites—direct underwriting (no profit or significant revenue expectation), voluntary donations, advertising or various subscription models—do not allocate web site costs based on usage. Even subscription models with varying levels—silver, gold platinum as but one example—are based not on actual usage but on expected, estimated or promised usage.

Given the foregoing, what is needed is a method of scalable web financing by micropayments that 1) equitably and automatically allocates costs among users with varying usage patterns; 2) lowers the risk in providing niche websites to smaller groups of users; 3) provides a funding source directly related to usage by particular users; 4) allows the web site to scale with demand; and 5) provides incentives for provision of content to a web site that is timely and useful.

### SUMMARY OF THE INVENTION

The disclosed invention meets the above-identified needs by providing a method of scalable web financing by micropayments.

In an aspect, a web site operator operates a web site. A web site account associated with a financial account is established for each user of a web site. When a user requests a content element from web site having a web site account for the user, the user's web site account is automatically debited to the extent of a determined microcost. In an aspect, funds are transferred from the user's web site account to a web site operator's account. In an aspect, determined microcosts of web site content elements may vary according to a factor selected from the group consisting of: time of day, type of content element, or demand for the content element, and cost average. In an aspect, costs may be averaged over a time period and used to determine microcosts of particular content elements within a particular time period. In an aspect, average costs may be determined in part based on the history of a particular content selection; type of content; frequency of use by a particular user or group of users; category of content, or content-provider. In an aspect, content-providers may receive credits that may be used to pay for future microcosts incurred by requesting web site content. In such an aspect, content-providers may also receive a share of micropayments received by the web site operator after a content element is requested.

An advantage of the present invention is that the web site is supported by its users according to the usage of the users. The burden of financing the web infrastructure is placed on the users with control of the web site by the operator of the web site.

Another advantage of the present invention is that a business hosted on the web site can grow advertisement-free.

Another advantage of the present invention is that a web site may scale with the usage of the web site, minimizing the risk of over-investment in web site resources or costs. As the web site usage increases, so does the available financing, which may be used to support additional web site resource investment. Knowledge web sites may be created according to an aspect, with each automatically finding its optimal level of usage for its users. An advantage of the present invention is that knowledge web sites may multiply, providing useful web site content to users on any subject, with resulting benefits to society and the economy.

Another advantage of the present invention is that an incentive is provided for content-providers to supply content that is timely and useful. When a content-element is highly accessed, the content-provider may be rewarded through micropayments or credits towards additional web site usage.

Another advantage of the present invention is that search engines internal to the web site may be developed proportionally to the web site actual usage. In an analysis engine, in an aspect, search engine indexing can be adjusted based on actual usage of web site content elements.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a flowchart illustrating an exemplary method of scalable web financing by micropayments.

FIG. 2 is a flowchart illustrating an exemplary method of scalable web financing by micropayments.

FIG. 3 is a block diagram illustrating an exemplary architecture of a computer that may be used for scalable web financing by micropayments.

### DETAILED DESCRIPTION

The present invention is directed to methods for scalable web financing by micropayments for the purpose of equitably and automatically allocating costs among users with varying usage patterns; 2) lowering the risk in providing niche websites to smaller groups of users; 3) providing a funding source directly related to usage by particular users; 4) allowing a web site to scale with demand; and 5) providing incentives for provision of content to a web site that is timely and useful.

It should be understood that the term “user” and/or the plural form of this term are used interchangeably throughout herein to refer to those persons capable of accessing, using, be affected by and/or benefiting from the tool that the present invention provides for scalable web financing by micropayments. Without in any way limiting the foregoing, a “user” may also refer to a group, organization or representative.

It should further be understood that the term “content-provider” and/or the plural form of this term are used interchangeably throughout herein to refer to those persons supplying content to the web site. The term “content-owner” and/or the plural form of this term are used interchangeably throughout herein to refer to entities that own the content or content elements within a web site. Without in any way limiting the foregoing, a “content-provider” and “content-owner” may also refer to a group, organization or representative. A content-provider may also be a content-owner and a content-owner may be a content-provider.

The term “content” and/or the plural form of this term are used interchangeably throughout herein to refer to any information that is made available by the website for its users. Content may be in any format, including but not limited to text, picture, audio, video or any combination. Content may also include forms of content that are time-dependent, as when the content may be available in the future, or subscription-oriented, as in a subscription to an email service or twitter service. The term “content-element” and/or the plural form of this term are used interchangeably throughout herein to refer to any particular content that may be requested by a user.

Furthermore, the terms “site” or “web site” and/or the plural form of these terms are used interchangeably throughout herein to refer to any collection of software and/or hardware that provides content in response to a request from a web browser. “Web site operator” shall mean the organization that is responsible for operating the web site, in particular, the organization having a financial account that pays the costs for operating the web site and receives funds from users or other parties.

An “account” as used herein, may include any device, code, number, letter, symbol, digital certificate, smart chip, digital signal, analog signal, biometric or other identifier/indicia suitably configured to allow a user to access, interact with or communicate with a web site. The account may have a number optionally located on or associated with any transaction instrument (e.g., rewards, loyalty, charge, credit, debit, prepaid, telephone, embossed, smart, magnetic stripe, fob, bar code, transponder or radio frequency card). The account number may be distributed and stored in any form of plastic, electronic, magnetic, radio frequency (RF), wireless, audio and/or optical device capable of transmitting or downloading data from itself to a second device (e.g., a POS terminal). A “financial account” as used herein may include an account at a financial institution or similar organization including, without limitation, a bank or credit card supplier. A “web site account” as used herein may include without limitation, one or more databases of information about the user, including history of usage, personal data including reference and access data on one or more financial accounts, and availability of funds. It should further be understood that the term “account,” “web site account,” and “financial account” may refer to an account held by a user or group of users, or by a web site or organization operating a web site. Users, content-owners and web site operators may have one or more web site accounts and financial accounts.

To “access content” as used herein means without limitation to use any kind of media player to experience content that is available on a web site. Examples include, but are not limited to, sound speakers or earphones for audio, LCD or similar screens for visual or video content, images or text—or any other device used to render and experience web site content. Further examples of such devices include, but are not limited to, wireless devices, cellular phones, and portable music or video devices.

It should further be understood that the term “fund” and/or the plural form of this term are used interchangeably throughout herein to refer to currency; i.e., cash or cash equivalents that are shown as available in a financial account. It should be further understood that the term “micropayment” and “microcost” and/or the plural forms of these terms are used interchangeably throughout herein to refer to funds that may total less than one cent in United States currency. Micropayments and microcosts may refer to funds in any currency, however.

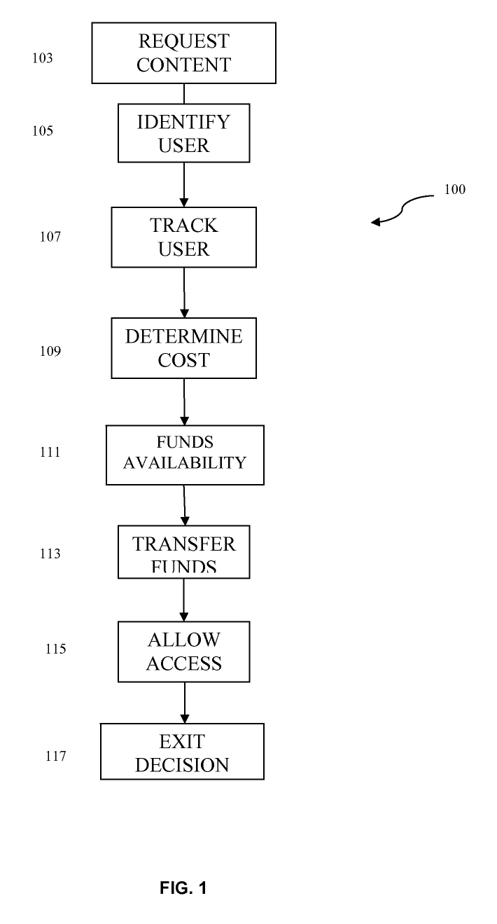

FIG. 1 shows an exemplary aspect of a web method 100 in accordance with an aspect of the present invention. The following description is for convenience only and is not intended to limit the application of the present invention. In fact, after reading the following description, it will be apparent to those skilled in the relevant art(s) how to implement the following invention in alternative aspects.

In an aspect, a web site operator operates a web site. At step 103, the user requests content from a web site. Content may include, but is not limited to, web pages or elements thereof, including, without limitation, documents, links, files, photos, video, audio or any type of content that may be accessed by a user of a web site. Requests may be made by any reasonable method of operating a web site by a user. Typically, web sites are operated via the use of a mouse or keyboard, however nothing in this description, in an aspect, is intended to limit ways a user can interface and operate a web site.

At step 105 a user is identified by the web site. Identification may include logging into a previously established account, with username and password, or establishing one or more new accounts through a registration process. In an aspect, the web site may recognize the user and identify the user automatically. In an aspect, the step of identification may include accessing and comparing one or more databases of usage and users. For example, and without limitation, identification may include without limitation accessing a web site account containing databases, information on personal data (including banking or credit information and available financial accounts), usage history, information including funding availability in a web site account, and content interests. In an aspect, users may update any of the information in their web site account including without limitation removing information or deleting the account itself.

In an aspect, user activity is tracked at step 107. In such an aspect, a data record may be created that is a repository for data concerning the user's progress and activities on the web site. At any particular time during the use of the web site, data may be accessed from one or more internal or external databases that help the web site operator provide a service that is valued and desired by users. Examples of such databases include, but are not limited to, history of usage, preferences, financial information including banking and credit, etc. In an aspect, a data record is updated with information on the user's current activity at a web site. In an aspect, users have the ability to view and update their data records.

In an aspect, at step 109, the microcost of the content being requested is determined. Factors that may contribute to the determination of a microcost include, but are not limited to, authoring, editing, coding, hosting, improving and serving the requested content. In an aspect, an average microcost is calculated. In such an aspect, an example calculation of “average microcost” is the total cost of the website content, including coding, hardware, software, hosting and other costs, divided by the number of content elements eligible to be requested, then, divided again by the total number of users. In such an aspect, microcosts are automatically allocated to each content element, and may vary for each element of a web site. The web site may count the number of users of the web site and the number of content elements. The web site also may track the costs of the web site. In an aspect, some of these costs may be pre-established by the web site operator and stored in a web site database.

In an aspect, the pricing of web site content elements may vary according to at least one of the following: time of day, type of content element, category of content element, demand for the content element, or cost average. In an aspect, costs may be averaged over a time period and used to determine microcosts of particular content elements in a particular time period. In such an aspect, costs may be allocated to a particular time period, in whole or in part. In an aspect, average costs may be determined in part based on the history of a particular content selection; type of content; frequency of use by a particular user or group of users; category of content, or content-provider. In an aspect, an average cost of particular content elements may be taken from a selection of content elements according to one or more categories. For example, and without limitation, a selection of content elements in an aspect may comprise content elements in a particular format, such as all audio content elements. In such an aspect, a selection of content elements may comprise content elements that pertain to a particular subject area. It should be understood that a category may include one or more sub-categories, in an aspect.

In an aspect, content-providers may receive credits that may be used to pay for future microcosts incurred by requesting web site content. In such an aspect, content-providers may also receive a share of micropayments received by the web site operator after a content element is requested.

In an aspect, at step 111 whether funds are available is determined. Using the data obtained at least in part during step 103, a comparison is made between the cost calculation result of step 109 and the amount of funds available. In an aspect, when sufficient funds are not available, access to the content requested at step 107 may not be permitted. In such an aspect, users may be provided an opportunity to increase funds, or to specify a different user financial account.

In an aspect, when sufficient funds are available, at step 113 funds are transferred from the user's web site account to the web site operator's financial account in an amount equal to the cost established at step 109. In an aspect, various accounts of the user or the web site operator may be debited or credited. In such an aspect, a user may be provided with a promotional or temporary web site account to allow the user to try the service without incurring a financial obligation. In an aspect, promotional funds may be supplied to the user's web site account. It should be understood that transferring funds may be undertaken in any commercial manner, including without limitation, pooling funds in a single bank account while tracking allocation and transfers of funds among web site accounts, with a database and computer software code. In such an aspect, transferring funds is an update to a database entry for the transferor and transferee. In an aspect, accounts may be kept separate, or may be grouped in ways advantageous to the operation of the web site and its users.

In an aspect, at step 115 the web site allows access by the user to the content requested at step 103. The content in such an aspect may be accessed in real time or saved to the device being used by the user to access the requested content. It should be understood that content may be accessed by a user with any suitable device, including, without limitation, display of a personal computer, cellular phone or other wireless device, sound device or video device.

In an aspect, at step 117 the user decides to exit the web site or request additional web site content. An exit decision includes the option to log off the web site. Without limitation, “log off” means at least, clicking a log off button thereby asking the web site to log off the user, or leaving the web site, or shutting down the web browser and/or device hosting the web browser.

In an aspect, step 113 may include transferring a portion of the funds to the owner of the requested content rather than a web site operator account. In such an aspect, step 107 may include ascertaining the owner of the requested content as well as identifying an associated content-owner financial account.

In an aspect, content-providers that supply content to the web site may be provided a credit for usage at the web site. In such an aspect, the content owner's web site account may receive a credit. In such an aspect, the amount of the credit depends on the frequency the content-provider supplies content or, in a further aspect, may depend on web site measures of success as applicable to the content provider, or may depend on other factors. As an example, without limitation, the credit made available to a content-provider may equal ten times the allocated microcost for the content.

In an aspect, microcosts may be determined based in part on the extent of previous micropayments. In such an aspect, the average cost may be recalculated to a lower value when some of the costs have been recovered. A microcost allocated to a particular content-element may be redetermined after transfer of a micropayment following the access of the particular content-element.

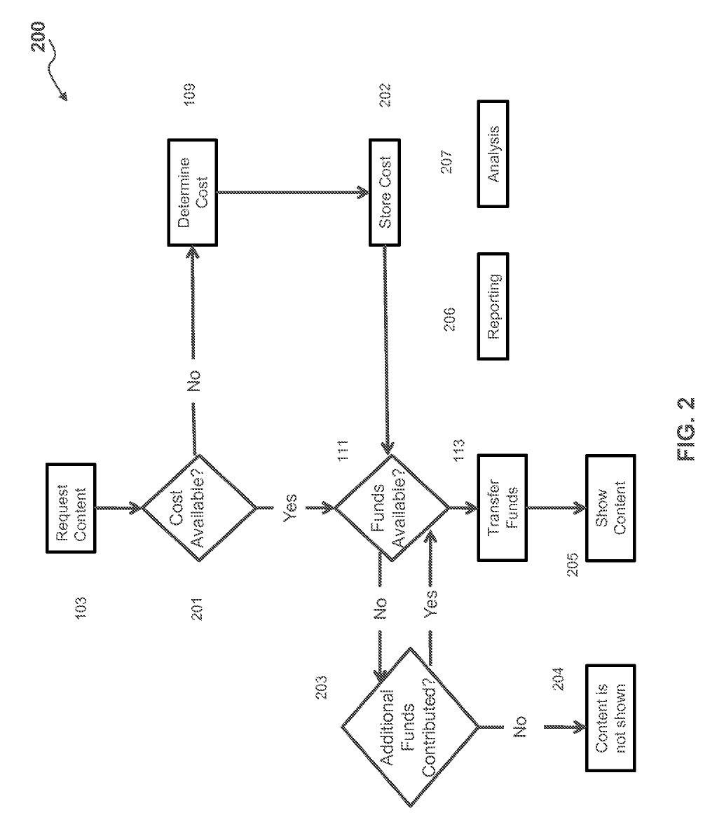

FIG. 2, in an aspect, shows an exemplary aspect of a web method 200 after content is requested 103. In an aspect, at step 201 ascertains whether a cost for that content is available; as an example, whether a cost may be automatically associated with the content that is requested in step 103. If no cost is available, a cost may be automatically determined as in step 104. Once cost is determined, at step 202 the cost may be stored in a suitable database, or made available to the reporting engine, to be described herein.

If funds are not available as per step 105, step 203 ascertains whether additional funds are contributed. Funds may be contributed according to any reasonably available electronic method. In an aspect, the system will recognize insufficient funds and prompt the user to add additional funds. In such an aspect, the system will debit a user account or credit card for funds. When a user declines to supply additional funds, the content requested at step 103 is not displayed. When funds are available, funds are transferred 106.

At step 205, content is displayed using an interface device appropriate for the type of content. For example, in an aspect, if the type of content to be accessed is audio, then an audio system and speakers or headphones may be used. If visual content, then a LCD display or similar device is used. However this description is not intended to be limiting in any way as to how a user may access and use content that is requested at step 103.

Additional aspects to the invention may be seen by one skilled in the art. In an aspect, a reporting step 206 may be used to collect information on usage patterns, cost calculations and the like in order to prepare various reports that the user or web site operator may need. For example, a user may be interested in their history of usage and the payments associated with that usage. Another example may be to assist management with understanding the most popular content elements and the heaviest of the users—the web site's best customers. Without limitation, a reporting step is designed to assist the operation of the web site in particular to web site operators to scale the web site with increased use by reporting to the web site operator data about the web site and its usage. While reporting step 206 is not shown to be directly connected to any steps within FIG. 2, it is to be understood that the reporting step 206 accepts data from any of the indicated method steps, or all of the steps, as may be called for in various aspects. It is to be understood that reporting step 206 may collect report data in an aspect, without limitation.

An analysis step 207 is also shown within FIG. 2. Analysis step 207 may accept data from any of the indicated method steps including, without limitation, reporting step 206, or all of the steps, as may be called for in various aspects. In an aspect, the analysis step may operate on collected data to make predictions of future usage or other operating characteristics, including, without limitation, number of users, peak time periods, most requested content and aspects thereof, most frequent users, etc. In an aspect, analysis step 207 may operate on collected data to analyze past usage according to direction from a web site operator. Without limitation, analysis step 207 may analyze number of users, peak time periods, most requested content and aspects thereof, most frequent users, etc. Analysis step 207 may use reporting step 206 as either a data repository, in an aspect, or to report the results of its analysis, also in an aspect.

In an aspect, a system of web financing using micropayments is contained within one or more computers. In an aspect, at least one computer is a web server. In an aspect, the system is connected to the internet via local network wired or wireless connections. In an aspect, portions of the system may be built upon dedicated hardware devices for purposes of obtaining cost information or displaying content. An example may include a barcode reader, credit card device, debit terminal or similar data input device.

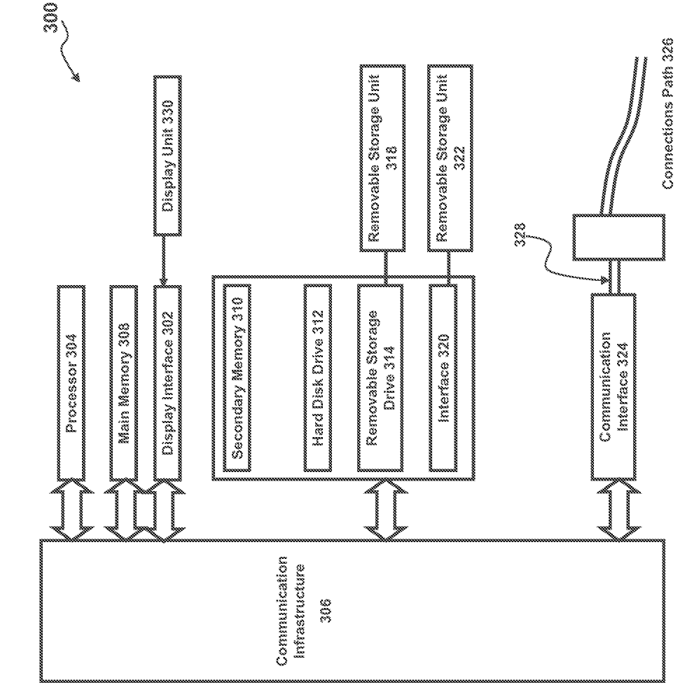

Referring to FIG. 3, a system diagram 300 of various hardware components and other features in which the present invention, in an aspect, would be implemented is shown. As shown in FIG. 3, in an aspect of the present invention, the invention is directed toward one or more computer systems capable of carrying out the functionality described herein.

The computer system 300 includes one or more processors, such as processor 304. The processor 304 is connected to a communication infrastructure 306 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative aspects, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. Signals 328 may represent data on content or data generated through analysis. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an aspect where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the invention is implemented using a combination of both hardware and software.

In one aspect of the present invention, computer system 300 may be consist of one or more PCs, minicomputers, mainframe computers, microcomputers, server computers, PDA's, cellphones or other devices having a one or more processors. That is, in such an aspect, computer system 300 may be a typical Web server (or collection of Web servers) running one or more server applications at a Web site which send out Web pages in response to Hypertext Transfer Protocol (HTTP) or Hypertext Transfer Protocol Secured (HTTPS) requests from remote browsers. Thus, in an aspect, computer system 300 is able to provide a graphical user interface (GUI) to users of system 200 in the form of web pages. These web pages may be sent to a user's PC, laptop, mobile device, PDA or like terminal device and result in the GUI screens being displayed.

In an alternative aspect, the number of users for purposes of determining cost consists only of active users. An “active user,” in an aspect, is a user that has accessed the website at least once within a predetermined period of time. In an aspect, such period of time is selected from one of the following: one week, one day, one year, or one month. In alternative aspects, the period of time is a variable selected by the web site operator.

In an alternative aspect, the cost of requested content 103 may be debited and recalculated for future use.

In an alternative aspect, partial funds may be sufficient to show content 205.

In various alternative aspects, refunds may be supplied to users that close their web accounts, or where requested content was unavailable or nonfunctional.

In an alternative aspect, funds may be grouped in order to minimize fund transfers, or to transfer non-fractional balances, where a fractional balance may be less than one cent in United States currency.

While various aspects of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary aspects.

In addition, it should be understood that the figures in the attachments, which highlight the structure, methodology, functionality and advantages of the present invention, are presented for example purposes only. The present invention is sufficiently flexible and configurable, such that it may be deployed and implemented in ways other than that shown in the accompanying figures.

1. A computer-implemented method of financing a web site using micropayments, on a computer, said computer comprising a processor, memory and communications interface, said computer programmed to perform said method comprising:
receiving a request for web site content from a user via said communications interface;
identifying said user via said processor and memory;
associating said identified user with a user web account and a user financial account via said processor and memory;
automatically determining a microcost associated with said requested web site content via said processor and said memory;
determining whether funds are available in said user web account via said processor and said memory;
allowing said identified user to access said requested content when said user web account contains funds that are greater than said microcost via said processor, said memory and said communications interface; and
transferring a micropayment equivalent to said microcost from said user web account to a web site operator financial account via said processor and said memory.

2. The method of claim 1, wherein automatically determining a microcost comprises retrieving said microcost from a database.

3. The method of claim 1, wherein automatically determining a microcost comprises deriving said microcost from an average cost.

4. The method of claim 1, wherein automatically determining a microcost comprises:
storing the microcost in a database.

5. The method of claim 1, wherein transferring a micropayment comprises grouping micropayments prior to transferring.

6. The method of claim 1, wherein transferring a micropayment comprises transferring a micropayment equivalent to said microcost from said user web account to a content-provider financial account via said processor and said memory.

7. The method of claim 1, wherein allowing, via said processor, said memory and said communications interface, comprises:
providing said identified user with an opportunity to contribute additional funds to said identified user's web site account from a said identified user's financial account when said user web account contains funds that are less than said microcost.

8. The method of claim 1, wherein allowing, via said processor, said memory and said communications interface, comprises:
providing said identified user with funds from a web site promotional account when said user web account contains funds that are less than said micro-cost.

9. The method of claim 1, wherein automatically determining a microcost comprises varying said determined microcost by a factor selected from the group consisting of: time of day, type of content element, and demand for the content element.

10. The method of claim 1, wherein the step of automatically determining a microcost comprises adjusting said microcost based on an analysis of the web site usage.

11. The method of claim 1, comprising automatically redetermining said microcost after said transferring of said micropayment via said processor and said memory.

12. A computer-implemented method of using micropayments to finance provision of content to a web site, on a computer, said computer comprising a processor, memory and communications interface, said computer programmed to perform said method comprising:
receiving a request to provide content from a content-provider, via said communications interface and said processor;
identifying said content-provider via said processor and memory;
associating said identified content-provider with a content-provider web account and a content-provider financial account via said processor and memory;
receiving said content via said communications interface, said processor and said memory; and
transferring a micropayment from a user web account to said content-provider web site account when said content is accessed by said user via said communications interface, said processor and said memory.

13. The method of claim 12, wherein the step of transferring comprises crediting said content-provider web site account that allows said content-provider to access content on said web site without transfer of a microcost.
